(19) United States
(12) Patent Application Publication
(10) Pub. No.: US 2005/0232094 A1
(43) Pub. Date: Oct. 20, 2005

(54) Driving device and an optical apparatus

(75) Inventor: Takayuki Hoshino, Osaka-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA OPTO, INC.

(21) Appl. No.: 11/077,462

(22) Filed: Mar. 10, 2005

(30) Foreign Application Priority Data
Mar. 30, 2004 (JP) 2004-101091

(51) Int. Cl. G11B 7/00

(52) U.S. Cl. 369/44.11

(57) ABSTRACT

A driving device is provided with a piezoelectric actuator, a magnetic field generating member integrally attached to a movable member of the piezoelectric actuator and having a surface magnetic flux density that changes along advancing and retreating directions of the movable member, a magnetic field detector for detecting a magnetic field generated by the magnetic field generating member, and a detecting circuit for calculating the position of the movable member in accordance with a detection signal of the magnetic field detector. The magnetic field detector includes first and second magnetic field detecting elements fixedly juxtaposed near a movement path of the magnetic field generating member. The driving device is capable of precisely detecting the position of the movable member by an inexpensive and simpler construction, and is applicable for an optical apparatus.

This application is based on patent application No. 2004-101091 filed in Japan, the contents of which are hereby incorporated by references.

### BACKGROUND OF THE INVENTION

The present invention relates to a driving device applied to various precision driving units and particularly to a driving device suitably applied to a lens driving mechanism or the like of an optical apparatus such as an electronic camera, an image sensing apparatus or a light pickup.

Various driving devices have been proposed as those to be applied to lens driving mechanisms of image sensing apparatuses, light pickups and the like. The driving devices can be roughly divided into those of the magnetic source type using an electromagnetic motor as a driving source and those of the nonmagnetic source type using a piezoelectric actuator or the like as a driving source. As one example of the former type, a driving device in which a driving field magnet is stationarily fixed relative to a movable member is disclosed, for example, in Japanese Unexamined Patent Publication No. H08-275496. In this driving device, the position of the movable member is detected based on a displacement detected by a magnetic sensor integral to the movable member. Since the driving source for displacing the movable member is an electromagnetic sensor, bypass filtering is applied in accordance with the driving speed of the movable member to remove an offset lest the offset should be superimposed on an output of the magnetic sensor due to the leakage magnetic fluxes created from the field magnet.

As one example of the latter type, a driving device using a piezoelectric actuator as a driving source is disclosed, for example, in Japanese Unexamined Patent Publication No. 2000-205809. This driving device adopts a technique of detecting the position of a movable member frictionally engaged with a driving member fixed to one end of a piezoelectric element, taking advantage of the electric resistance of the driving member. Japanese Unexamined Patent Publication No. 2003-185406 also discloses a driving device using a piezoelectric actuator as a driving source. In this driving device, the position of a movable member is detected based on a change in an electrostatic capacity between a movable electrode provided on the movable member and a fixed electrode provided on a fixed portion.

However, in the driving device of the first publication, the bypass filtering has to be applied in order to solve a problem that the offset is superimposed on the output of the magnetic sensor due to the leakage magnetic fluxes from the driving source (electromagnetic motor). This is disadvantageous in terms of costs and reliability due to the complicated detecting circuit. Another problem is that it is difficult to precisely produce the field magnet in which the N-pole and the S-pole are alternately arranged to have a high resolution.

On the other hand, the driving devices having a non-magnetic source disclosed in the second and third publications do not encounter the above problem, but have the following problems in detecting the position of the movable member.

(1) The driving device of the second publication adopts a contacting sensing method for detecting the position of the movable member using the electrical resistance of the driving member, and it is difficult to obtain a high resolution since the contact resistance of the movable member and the driving member varies. The driving member having a light weight and a high rigidity is demanded in order to improve the performance of the actuator. It is difficult to select the material for the driving member capable of providing a sufficient electrical resistance value for the sensing and the high rigidity.

(2) Although the driving device of the third publication adopts the non-contacting sensing means different from the above, an ac voltage needs to be applied to either the movable electrode or the fixed electrode, which is disadvantageous in terms of costs and reliability due to the complicated detecting circuit. Another problem is that the clearance between the fixed electrode and the movable electrode has to be minimized in order to obtain a high resolution.

Another problem from another angle is a reduction in the precision in detecting the position of the movable member resulting from a change in the operating environment of the driving device. For example, the magnetic sensor is used for the detection of the position of the movable member according to the technology of the first publication, but the sensing characteristic thereof changes with an ambient temperature. As a result, precision in detecting the position of the movable member is reduced due to a change of the ambient temperature and the like.

### SUMMARY OF THE INVENTION

It is an object of the present invention to provide a driving device and an optical apparatus which are free from the problems residing in the prior art.

It is another object of the present invention to provide a driving device which can precisely detect the position of a movable member by an inexpensive and simple construction, and an optical apparatus using this driving device.

According to an aspect of the present invention, a driving device includes a movable member integrally attached with a magnetic field generating member, a driver for moving the movable member in a direction, a magnetic field detector for detecting a change in a magnetic field resulting from a movement of the magnetic field generating member as the movable member moves, and a calculator for calculating the position of the movable member in accordance with a detection signal of the magnetic field detector. The surface magnetic flux density of the magnetic field generating member changes along the moving direction of the movable member. The magnetic field detector includes a plurality of magnetic field detecting elements fixedly juxtaposed near a movement path of the magnetic field generating member.

These and other objects, features and advantages of the present invention will become more apparent upon a reading of the following detailed description and accompanying drawings.

### BRIEF DESCRIPTION OF THE DRAWINGS

FIG. 1 is a diagram showing a system construction of a driving device according to an embodiment of the invention;

FIG. 2 is a construction diagram showing a position sensing section of the driving device in detail;

FIGS. 3A, 3B and 3C are diagrams showing a calculation result by a calculator provided in the driving device;

FIG. 4 is a graph showing a calculation result by the calculator;

FIGS. 5A, 5B and 5C are diagrams showing the operation principle of a piezoelectric actuator of the friction driving type;

FIG. 6 is a graph showing a displacement of a drive shaft of the piezoelectric actuator of the friction driving type;

FIG. 7 is a construction diagram showing a modified position sensing section of the driving device in detail;

FIG. 8 is a construction diagram showing another modified position sensing section of the driving device in detail;

FIG. 9 is a diagram showing a construction of an optical element driving system provided in an optical apparatus, the system including a driving device in accordance with an embodiment of the invention;

FIG. 10 is a block diagram showing a construction of a controller provided in the optical apparatus shown in FIG. 9; and

FIG. 11 is a diagram showing a construction of a modified optical element driving system of the optical apparatus.

### DETAILED DESCRIPTION OF THE PREFERRED EMBODIMETNS OF THE INVENTION

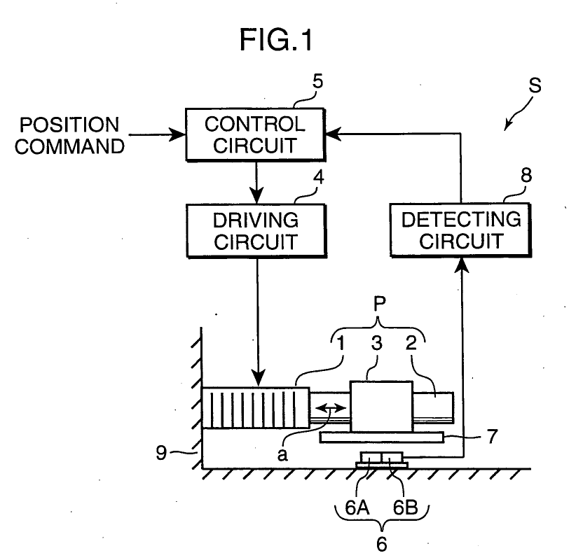

Referring to FIG. 1 showing a system construction of a driving device S according to an embodiment of the present invention, the driving device S is provided with a piezoelectric actuator or driver P, a driving circuit 4 for driving the piezoelectric actuator P, a control circuit 5, a magnetic field generating member 7 which is integrally attached to a movable member 3 of the piezoelectric actuator P and whose surface magnetic flux density changes along advancing and retreating directions, a magnetic field detector 6 for detecting a magnetic field generated by the magnetic field generating member 7, and a detecting circuit or calculator 8 for detecting the position of the movable member 3 in accordance with a detection signal of the magnetic field detector 6. It should be noted that the magnetic field detector 6, the magnetic field generating member 7 and the detecting circuit 8 construct a position sensing section for the movable member 3.

The piezoelectric actuator P includes an electromechanical converting element 1, a driving member or guiding shaft 2 fixed to one end of the electromechanical converting element 1, and the movable member 3 movably held on the driving member 2. A piezoelectric element such as a Piezo element can be suitably used as the electromechanical converting element 1. The driving member 2 is secured to one end of the electromechanical element 1 (hereinafter, “piezoelectric element 1”) along a direction of an electrostrictive strain or in an elongating direction by adhering or the like, so that the driving member 2 is moved in directions of arrow “a” as the piezoelectric element 1 elongates and contracts. On the other hand, the other end of the piezoelectric element 1 is fixed to a fixing portion 9 (main body of the driving device S or the like), thereby restricting an elongation range of the piezoelectric element 1.

The movable member 3 is a member for giving a moving force to a drivable element such as a lens barrel or a movable piece of a precision stage. This movable member 3 is formed with a through hole, into which the driving member 2 is introduced to mount the movable member 3 on the driving member 2 by a specified frictional engaging force.

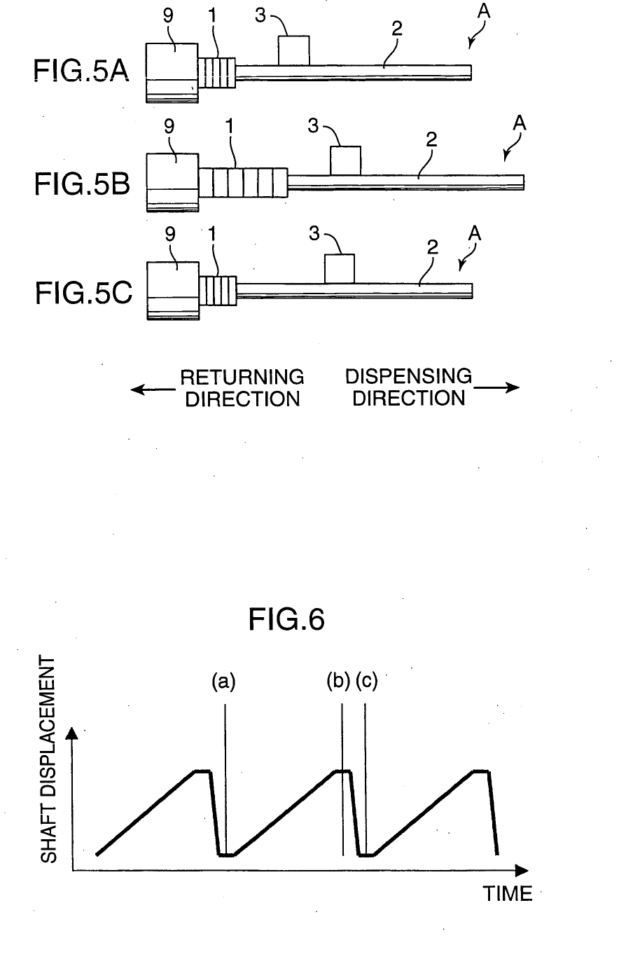

FIGS. 5 and 6 are diagrams showing the operation principle of the piezoelectric actuator P as above, wherein FIGS. 5A, 5B and 5C are diagrams showing advancing and retreating movements of the movable member 3 on the driving member 2, and FIG. 6 is a graph showing a displacement of a shaft of the driving member 2. In other words, a voltage having a sawtooth drive pulse is given to the piezoelectric element 1 so that the shaft of the driving member 2 makes such a displacement as shown in FIG. 6. The respective states of FIGS. 5A, 5B and 5C correspond to time points A, B, C in FIG. 6.

In the assumption that the state of FIG. 5A is an initial state, upon transiting to the state of FIG. 5B, i.e., upon the elongation in dispensing direction, the piezoelectric element 1 (driving member 2) undergoes a moderate elongating displacement as shown in the graph of FIG. 6. Since the driving member 2 is moved in the dispensing direction at a moderate speed accordingly, the movable member 3 frictionally engaged with the driving member 2 is synchronously displaced by the frictional engaging force, following the displacement of the driving member 2. Upon transiting from the state of FIG. 5B to the state of FIG. 5C, i.e., when a sudden falling part of the sawtooth drive pulse voltage is applied to the piezoelectric element 1, the piezoelectric element 1 quickly contracts. Since the driving member 2 is moved in a returning direction at a fast speed according to the contraction of the piezoelectric element 1, slip is created in the frictionally engaged portion of the movable member 3 and the driving member 2. The movable member 3 is slightly returned in the returning direction without being displaced following the displacement of the shaft of the driving member 2 by this slip. Such operations are repeated to move the movable member 3 away from the piezoelectric element 1 along the shaft of the driving member 2.

It is desirable to use the driver of the so-called “non-magnetic source type” such as the above piezoelectric actuator P as the driver used in the present invention. Specifically, it is desirable that the density of the surface magnetic fluxes generated as the movable member 3 of the driver advances and retreats is 0.1 mT or lower and a maximum value of the density of the surface magnetic fluxes generated by the magnetic field generating member 7 is 1 mT or higher. In this way, the movable member 3 can be highly precisely positioned without disturbing the detection signal of the magnetic field detector 6 by the leakage magnetic flux by suppressing the density of the surface magnetic fluxes generated by the movement of the driver to about 1/10 of the density of the surface magnetic fluxes generated by the magnetic field generating member 7.

In addition to the piezoelectric actuator P having the above construction, a supersonic actuator for advancing and retreating the movable member 3 using a supersonic motor and a shape memory actuator for advancing and retreating the movable member 3 using a shape memory member can be cited as such a driver of the “non-magnetic source type”.

Referring back to FIG. 1, the control circuit 5 generates a drive control signal for moving the movable member 3 to a commanded position upon receiving a position command (displacement command of the movable member 3) given from an unillustrated upper computer. This drive control signal is so generated as to move the movable member 3 by a specified distance in accordance with a difference between a position signal of the movable member 3 sent from the detection circuit 8 and a position signal based on the position command.

The drive control signal thus generated is inputted to the driving circuit 4. The driving circuit 4 generates a drive signal for driving the piezoelectric element 1 to move the movable member 3 by the specified distance in accordance with the drive control signal, thereby actually driving the piezoelectric element 1.

The magnetic field generating member 7 is integrally attached to the movable member 3 so as to be movable in advancing and retreating directions as the movable member 3 advances and retreats. This magnetic field generating member 7 may be directly fixed to the movable member 3 or may be indirectly mounted on the movable member 3 by being fixed to a drivable member mounted on the movable member 3. A member whose surface magnetic flux density is changed along the advancing and retreating directions of the movable member 3 is used as the magnetic field generating member 7. A changed state of the surface magnetic flux density is not particularly restricted, and any changed state will do provided that the surface magnetic flux density changes relative to the fixedly disposed magnetic field detector 6 as the magnetic field generating member 7 advances and retreats. A specific example of the changed state is described in detail later.

The magnetic field detector 6 is for detecting a change of the magnetic field as the magnetic field generating member 7 is moved following the advancing and retreating movements of the movable member 3, and includes a first magnetic field detecting element 6A and a second magnetic field detecting element 6B fixedly juxtaposed near a movement path of the magnetic field generating member 7. Although the two magnetic field detecting elements are used in this embodiment, three or more magnetic field detecting elements may be juxtaposed. Further, although the two magnetic field detecting elements 6A, 6B are arranged along the moving direction of the movable member 3, a plurality of magnetic field detecting elements may be juxtaposed along a direction normal to the advancing and retreating directions of the magnetic field generating member 7 if the surface magnetic field density of the magnetic field generating member 7 used changes along this normal direction.

Various magnetic sensors can be used as the magnetic field detecting elements 6A, 6B. Magnetic field detecting elements for outputting an electrical signal in response to a detected magnetic field such as MR elements using a magnetoresistance effect and Hall elements using a Hall effect can be cited as representative examples. Out of these examples, the Hall elements can be suitably used since they are generally small-sized, has a good mountability into the driving device S of this type and are inexpensive.

The detecting circuit 8 functions as a calculator for calculating the position of the movable member 3 in accordance with the detection signal of the magnetic field detector 6. Specifically, magnetic field detection signals detected by the first and second magnetic field detecting elements 6A, 6B are inputted to the detecting circuit 8, which generates a position signal representing the current position information of the movable member 3 by amplifying and operating the two magnetic field detection signals. The position signal generated here is outputted to the control circuit 5.

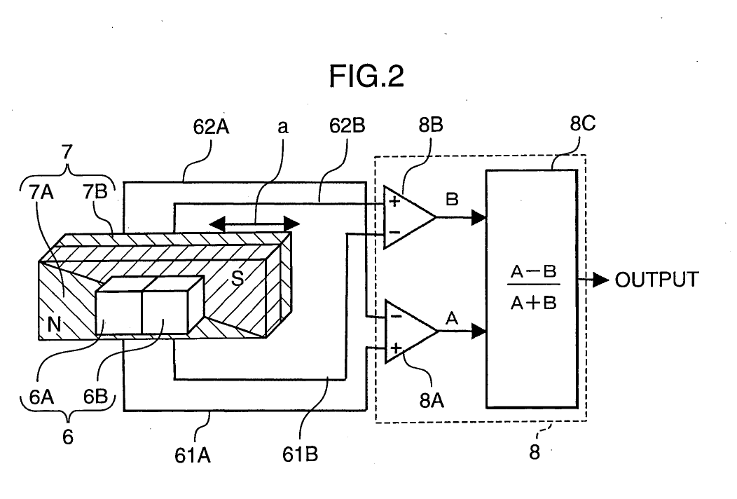

FIG. 2 is a construction showing a section forming the position sensor in the detecting device S, i.e., one example of the position sensing section comprised of the magnetic field detector 6, the magnetic field generating member 7 and the detecting circuit 8 in detail. In this embodiment, the magnetic field generating member 7 used includes a positively magnetized portion dominantly positively magnetized, a negatively magnetized portion dominantly negatively magnetized, and an intermediate portion disposed between the positively and negative magnetized portions for canceling the positive magnetization and negative magnetization, the three portions being arranged along the advancing and retreating directions of the movable member 3. Such a magnetic field generating member 7 whose magnetism creating conditions: the positively magnetized portion, the negatively magnetized portion and the intermediate portion, differ along the advancing and retreating direction of the movable member 3 moves as the movable member 3 advances and retreats. Thus, there is an advantage of enlarging a magnetic field change resulting from the advancing and retreating movements of the movable member 3.

As shown in FIG. 2, the magnetic field generating member 7 is comprised of a substantially triangular first magnet 7A positively magnetized in thickness direction (i.e., surface facing the magnetic field detector 6 is N-pole and the opposite surface is S-pole), and a substantially triangular second magnet 7B negatively magnetized in thickness direction (i.e., surface facing the magnetic field detector 6 is S-pole and the opposite surface is N-pole). Oblique sides of the first and second magnets 7A, 7B are opposed and secured to each other, thereby forming the magnetic field generating member 7 having a substantially rectangular shape. If the magnetic field generating member 7 has such a structure, an N-pole section and an S-pole section smoothly switch according to the shape of the oblique surfaces. Accordingly, if such a magnetic field generating member 7 is moved along the advancing and retreating directions of the movable member 3, i.e., in the directions of arrow “a”, the detected surface magnetic flux density substantially linearly changes if the magnetic field is observed at a fixed point.

Such a magnetic field generating member 7 is so fixed to the movable member 3 as to face the magnetic field detector 6. The first and second magnetic field detecting elements 6A, 6B are fixedly juxtaposed along the advancing and retreating directions of the magnetic field generating member 7. Accordingly, if the magnetic field generating member 7 is moved along the directions of arrow “a”, the magnetic fields around the first and second magnetic field detecting elements 6A, 6B respectively change as the density of the surface magnetic fluxes generated from the magnetic field generating member 7 changes. Thus, the output detection signals of the first and second magnetic field detecting elements 6A, 6B also change. Further, the magnetic flux densities detected at the same time by the first and second magnetic field detecting elements 6A, 6B differ depending on the arranged positions of the first and second magnetic field detecting elements 6A, 6B since the magnetic field generating member 7 is so shaped as to moderately change from the N-pole section to the S-pole section. In other words, the surface magnetic flux density takes a maximum value near the left end in FIG. 2 along the advancing and retreating directions, becomes zero in the middle and takes a maximum negative value (absolute value) near the right end in FIG. 2, and a change thereof is substantially linear. Thus, different surface magnetic flux densities are detected at the same time by the first and second magnetic field detecting elements 6A, 6B.

The width of the magnetic field generating member 7 along the advancing and retreating directions is desirably selected to be such a dimension as to secure a facing relationship of the magnetic field generating member 7 and the magnetic field detector 6 regardless of at which position the movable member 3 is located in its moving stroke range. Specifically, in the case that the magnetic field detector 6 is so fixedly arranged as to face the magnetic field generating member 7 that advances and retreats together with the movable member 3, it is desirable to select the shape of the magnetic field generating member 7 such that the magnetic fluxes from the magnetic field generating member 7 act on the magnetic field detector 6 over the entire movable range of the movable member 3. Such a construction is preferable since the position of the movable member 3 can be detected in the entire stroke range of the movable member 3. Since detection precision is reduced if a clearance between the magnetic field generating member 7 and the magnetic field detector 6 is too large while there is a danger of bringing the magnet 7 and the magnetic sensor 6 into contact if this clearance is too small. Therefore, this clearance is desirably set at about 0.1 to 0.3 mm.

With the magnetic field generating member 7 obtained by adhering the substantially triangular first and second magnets 7A, 7B having different directions of magnetization, a change of the magnetic fluxes resulting from the movement of the magnetic field generating member 7 appears not only along the advancing and retreating directions of the movable member 3, but also along the direction normal to the surface extending in the advancing and retreating directions. Thus, the first and second magnetic field detecting elements 6A, 6B may be juxtaposed along the direction normal to the advancing and retreating directions.

In this embodiment, the detecting circuit 8 includes a first and a second adders 8A, 8B constructed by operational amplifiers, and a calculator 8C for calculating based on output values of the first and second adders 8A, 8B.

The first adder 8A is for amplifying an electrical signal outputted from the first magnetic field detecting element 6A upon detecting the magnetic field, wherein a plus-terminal 61A of the first magnetic field detecting element 6A is connected with a non-inverting input terminal of the first adder 8A and a minus-terminal 62A of the first magnetic field detecting element 6A is connected with an inverting input terminal of the first adder 8A.

The first adder 8B is for amplifying an electrical signal outputted from the second magnetic field detecting element 6B upon detecting the magnetic field, wherein a plus-terminal 61B of the second magnetic field detecting element 6B is connected with an inverting input terminal of the second adder 8B, and a minus-terminal 62B of the second magnetic field detecting element 6B is connected with a non-inverting input terminal of the second adder 8B.

The connection polarities of the first and second magnetic field detecting elements 6A, 6B with the first and second adders 8A, 8B are changed in this way in order to make the calculation in the calculator 8C at a succeeding step easier by inverting the polarities because the first magnetic field detecting element 6A dominantly detects the magnetic fluxes of N-pole while the second magnetic field detecting element 6B dominantly detects the magnetic fluxes of S-pole.

The calculator 8C calculates in accordance with the following equation if outputs A, B are an electrical signal outputted from the first magnetic field detecting element 6A and an electrical signal outputted from the second magnetic field detecting element 6B, respectively:
K·(A−B)/(A+B) (where K is a proportion constant)
and sends the calculation result to the control circuit 5 as the position information of the movable member 3. The purpose of letting the calculator 8C carrying out such a calculation of (A−B)/(A+B) is to improve an operating environment temperature characteristic of the signal representing the position of the movable member 3 detected by the detecting circuit 8. Specifically, the magnetic flux density of a magnet generally changes due to the temperature characteristic of the magnet if an ambient temperature changes. For example, if the ambient temperature increases, the surface magnetic flux density of the magnetic field generating member 7 decreases due to the temperature characteristics of the first and second magnets 7A, 7B of the magnetic field generating member 7. Accordingly, the output values of the first and second magnetic field detecting elements 6A, 6B tend to decrease as the ambient temperature increases. The calculator 8C carries out the above calculation so that the position of the movable member 3 can be detected without being influenced by the decreased output values of the first and second magnetic field detecting elements 6A, 6B resulting from such a change in the operating environment temperature.

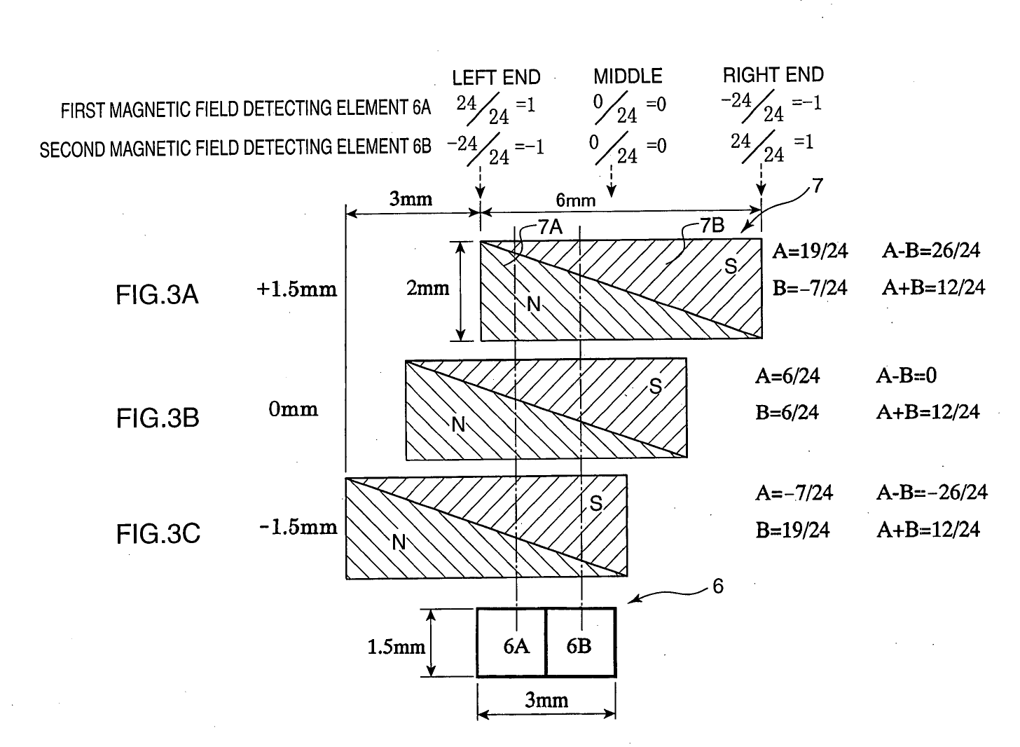

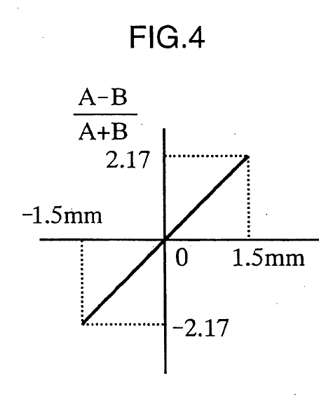

FIGS. 3 and 4 show the output A of the first magnetic field detecting element 6A, the output B of the second magnetic field detecting element 6B and the calculation result ((A−B)/(A+B)) of the calculator 8C in relation to the displacement of the magnetic field generating member 7. Although the N- and S-pole surfaces of the magnetic field generating member 7 are actually opposed to the magnetic field detector 6 as shown in FIG. 2, they are shown in development in FIG. 3 in order to easily show the positional relationship of the moved position of the magnetic field generating member 7 and the fixed positions of the first and second magnetic field detecting elements 6A. 6B.

Now, the magnetic flux density is thought to linearly change along a movable direction, assuming that a moving stroke of the movable member 3 is 3 mm; the magnetic flux density is zero in the middle of the magnetic field generating member 7 (if the center of the first or second magnetic field detecting element 6A or 6B is caused to face the middle of the magnetic field generating member 7, the detection output of the magnetic field detecting element is also zero); the magnetic flux density is 1 or −1 at the left end of the magnetic field generating member 7 along the movable direction (the detection output of the first magnetic field detecting element 6A is 1 if the center of the first magnetic field detecting element 6A is caused to face the left end of the magnetic field generating member 7 along the movable direction, whereas the detection output of the second magnetic field detecting element 6B is −1 if the center of the second magnetic field detecting element 6B is caused to face the left end of the magnetic field generating member 7 along the movable direction); and the magnetic flux density is −1 or 1 at the right end of the magnetic field generating member 7 along the movable direction (the detection output of the first magnetic field detecting element 6A is −1 if the center of the first magnetic field detecting element 6A is caused to face the right end of the magnetic field generating member 7 along the movable direction, whereas the detection output of the second magnetic field detecting element 6B is 1 if the center of the second magnetic field detecting element 6B is caused to face the right end of the magnetic field generating member 7 along the movable direction).

In the case that the magnetic field detector 6 is located near the left end of the magnetic field generating member 7 along the movable direction as shown in FIG. 3A, the output of the first magnetic field detecting element 6A is, for example, 19/24 if the magnetic field generating member 7 is located, for example, at a position of +1.5 mm. This output signal is inputted as the output A to the calculator 8C. On the other hand, the output of the second magnetic field detecting element 6B is, for example, − 7/24. It should be noted that this output signal is inputted as the output B to the calculator 8C while a minus sign of this output signal is converted into a plus sign by way of the second adder 8B. In this case, the calculation result of (A−B)/(A+B) by the calculator 8C is about 2.17.

If the magnetic field generating member 7 is located at a position of 0 mm as shown in FIG. 3B, the outputs of both first and second magnetic field detecting elements 6A and 6B are 6/24 and the calculation result of (A−B)/(A+B) by the calculator 8C is 0.

In the case that the magnetic field detector 6 is located near the right end of the magnetic field generating member 7 along the movable direction as shown in FIG. 3C, the output of the first magnetic field detecting element 6A is, for example, − 7/24 and that of the second magnetic field detecting element 6B is, for example, 19/24 if the magnetic field generating member 7 is located, for example, at a position of 11.5 mm. The calculation result of (A−B)/(A+B) by the calculator 8C at this time is about −2.17. In this way, a monotonously increasing characteristic in relation to the moved position of the magnetic field generating member 7 can be obtained as shown in FIG. 4.

As described above, when the operating environment temperature increases, the magnetic flux density decreases due to the temperature characteristic of the magnets and the outputs of the first and second magnetic field detecting elements 6A, 6B themselves become smaller. However, if the construction of letting the calculator 8C carry out the calculation as above is adopted, the calculation result of (A−B)/(A+B) by the calculator 8C remains to be 2.17 even if the outputs of the first and second magnetic field detecting elements 6A, 6B should decrease to halves of the above assumed values (outputs of the first and second magnetic field detecting elements 6A, 6B are respectively 19/48, − 7/48) when the magnetic field generating member 7 is located at the position of +1.5 mm in a high-temperature environment. The calculation result is invariable to a change of the operating environment temperature. Accordingly, the position of the movable member 3 can be detected without being substantially influenced by the change of the operating environment temperature of the driving device S.

In addition to using the calculation result of (A−B)/(A+B) by the calculator 8C as a signal representing the movable member 3, it may be used as a temperature sensor (temperature detector) taking advantage of the fact that the output values of the first and second magnetic field detecting elements 6A, 6B change with the operating environment temperature. In other words, the calculator 8C may be caused to function as a temperature detector for detecting temperatures where the magnetic field detecting elements are disposed in accordance with the signal value of the output A from the first magnetic field detecting element 6A, the signal value of the output B from the second magnetic field detecting element 6B or a sum of the outputs A and B.

In such a case, it is desirable to provide a position corrector for correcting the moved position of the movable member 3 in accordance with temperature information detected by the temperature detector. One example of such a position corrector may include a ROM or the like storing a look-up table (LUT) relating the temperature characteristic of a drivable member driven by the movable member 3 and a moved amount of the movable member 3, and a calculator for calculating a corrected moved amount by comparing the temperature detected by the temperature detector and the LUT. By providing such a position corrector, various controls (operating position correction, etc.) of the driving device can be executed using the temperature detection result. It is preferable because a control can be executed to advance and retreat the movable member 3 in consideration of the influence of the temperature change.

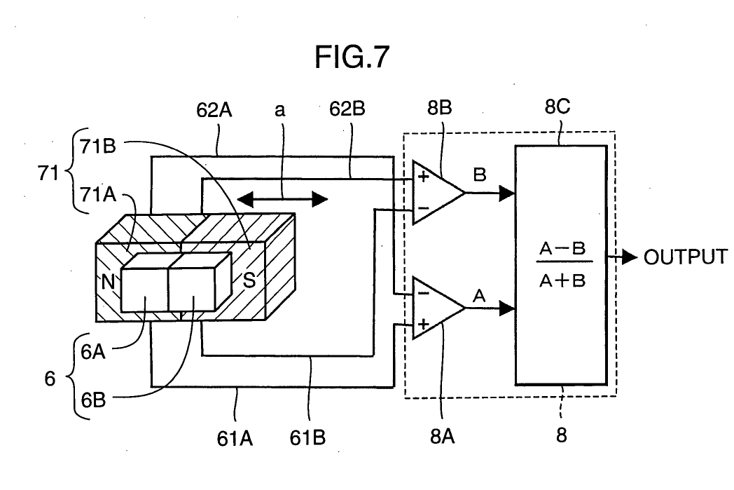

Referring to FIG. 7 showing another embodiment of the position sensing section in the driving device S, the embodiment is characterized in the use of a magnetic field generating member 71 made of a single rectangular magnet having an N-pole 71A and an S-pole 71B, and the other part is same as in the embodiment described above.

The magnetic field generating member 71 is arranged such that the N-pole 71A and the S-pole 71B are transversely juxtaposed along the advancing and retreating directions (directions of arrows “a” in FIG. 7). The magnetic field detector 6 is opposed to the magnetic field generating member 71 similar to the previous embodiment. For example, the magnetic field detector 6 is arranged such that a boundary between the first and second magnetic field detecting elements 6A and 6B coincides with a boundary between the N-pole 71A and the S-pole 71B when the movable member 3 is located at a home position (e.g., “0 mm” position described with reference to FIG. 3).

With such a magnetic field generating member 71, different from the magnetic field generating member 7 shown in FIG. 2, the surface magnetic flux density along the advancing and retreating directions of the movable member 3 suddenly changes at the straight boundary between the N-pole 71A and the S-pole 71B. In other words, the magnetic field detected by the first and second magnetic field detecting elements 6A, 6B largely changes before and after passing the boundary between the N-pole 71A and the S-pole 71B, i.e., passing the detection points in the respective magnetic field detecting elements. Thus, the magnetic field generating member 71 is suitable for the driving device S having a relatively narrow (e.g., about 1 mm) movable range of the movable member 3.

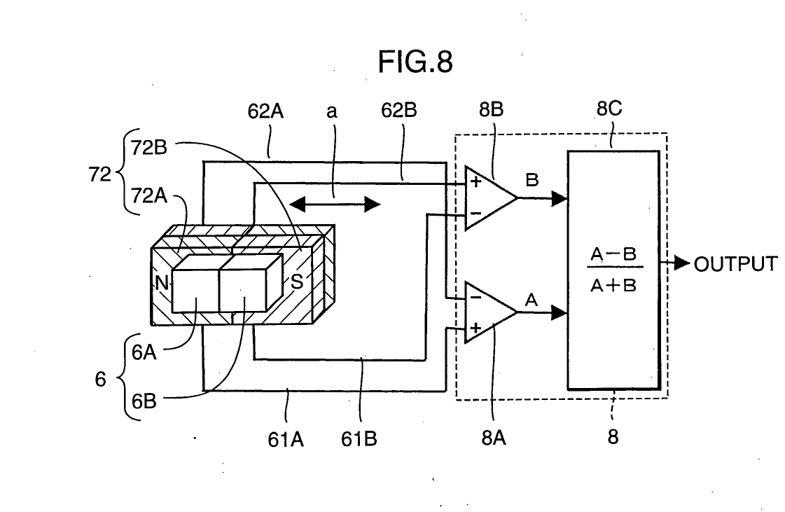

Referring to FIG. 8 showing still another embodiment of the position sensing section in the driving device S, this embodiment is characterized in the use of a magnetic field generating member 72 including a rectangular first magnet 72A positively magnetized in thickness direction and a rectangular second magnet 72B negatively magnetized in thickness direction and taking a substantially rectangular shape by securing facing side surfaces of the first and second magnets 72A, 72B to each other. The other part is same as in the embodiments described above.

Specifically, the magnetic field generating member 72 is such that the first magnet 72A has the N-pole located at the surface thereof facing the magnetic field detector 6, the second magnet 72B has the S-pole located at the surface thereof facing the magnetic field detector 6, and sides of both magnets 72A, 72B are secured to each other. The magnetic field generating member 72 and the magnetic field detector 6 are relatively arranged such that the boundary between the first and second magnetic field detecting elements 6A and 6B coincides with a boundary between the first and second magnets 72A, 72B. Since the magnetic field detected by the first and second magnetic field detecting elements 6A, 6B largely changes before and after passing the boundary between the first and second magnets 72A, 72B, i.e., passing the detection points in the respective magnetic field detecting elements in this embodiment as well, the magnetic field generating member 72 is similarly suitable for the driving device S having a relatively narrow movable range of the movable member 3.

Further, if the magnetic field generating member 72 as shown in FIG. 8 is used, the magnetic fluxes generated by the magnetic field generating member 72 propagate in a direction (direction extending from the back side of the plane of FIG. 8 to the front side thereof) normal to the magnetic field detector 6 opposed to the magnetic field generating member 72 since the first and second magnets 72A, 72B are positively and negatively magnetized, respectively. Thus, there is an advantage that more magnetic fluxes act on the magnetic field detector 6 and the magnetic field can be detected with good sensitivity.

Although the magnets are used as the magnetic field generating member 7 in the above embodiments, it is also possible to use magnetized sheets. In such a case, magnetized sheets whose surface magnetic flux density is several mT can be, for example, used.

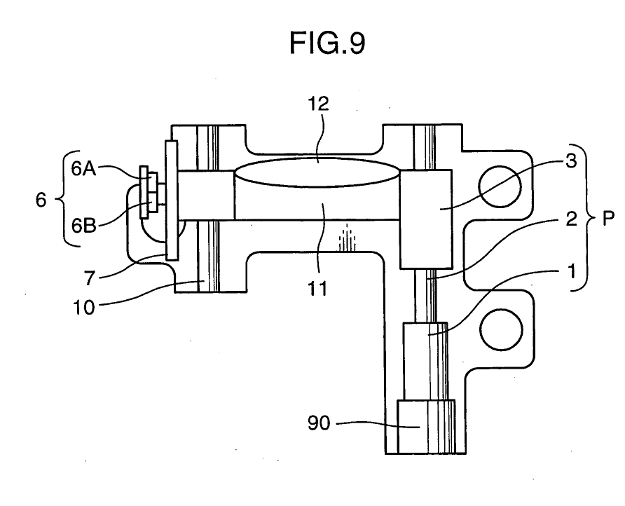

FIG. 9 shows a construction example in the case of applying the driving device S to a driving system for an optical component in an image sensing apparatus such as an electronic camera or an optical apparatus such as a light pickup. Specifically, FIG. 9 shows an embodiment in which an optical element is held by the movable member 3 of the driving device S described above in an optical apparatus provided with a mechanism in which at least one optical element is arranged on an optical axis, and is caused to advance and retreat along a guiding shaft provided therefor.

In FIG. 9 is shown a lens 12 held by a lens holder 11 as the optical element to be driven. This lens 12 is a lens (zoom lens) constructing a part of a photographing optical system in the case of application to an image sensing apparatus as the optical apparatus while being a lens constructing a part of a light pickup optical system in the case of application to a light pickup as the optical apparatus.

The optical apparatus according to this embodiment is provided with the lens 12 held by the aforementioned lens holder 11, the piezoelectric actuator P for causing the lens 12 to advance and retreat, the magnetic field generating member 7 secured to a lateral edge of the lens holder 11, the magnetic field generating member 6 opposed to the magnetic field generating member 7 and having the first and second magnetic field detecting elements 6A, 6B, and an auxiliary shaft 10 for guiding the lens holder 11.

The lens holder 11 has one end thereof mounted on (held by) the movable member 3 of the piezoelectric actuator P. This lens holder 11 is mounted to have such a positional relationship that an optical axis of the lens 12 and the advancing and retreating directions of the movable member 3 (i.e., extending direction of the driving member 2) are parallel. On the other hand, a through hole is formed at the other end of the lens holder 11, and the auxiliary axis 10 is introduced through this through hole. Accordingly, forces for advancing and retreating the lens holder 11 are given by the movable member 3 of the piezoelectric actuator P, whereby the lens holder 11 advances and retreats (movements along vertical direction of FIG. 9) while being guided by the auxiliary shaft 10. It should be noted that the piezoelectric element 1 of the piezoelectric actuator P is fixed to a mounting portion 90 provided on a main body of the optical apparatus.

The magnetic field generating member 7 is fixed to the lateral edge at the other end (side of the auxiliary shaft 10) of the lens holder 11 instead of being directly mounted on the movable member 3, and the magnetic field detector 6 is opposed to the magnetic field generating member 7. The magnetic field detector 6 and the magnetic field generating member 7 can adopt any one of the constructions shown in FIGS. 2, 7 and 8.

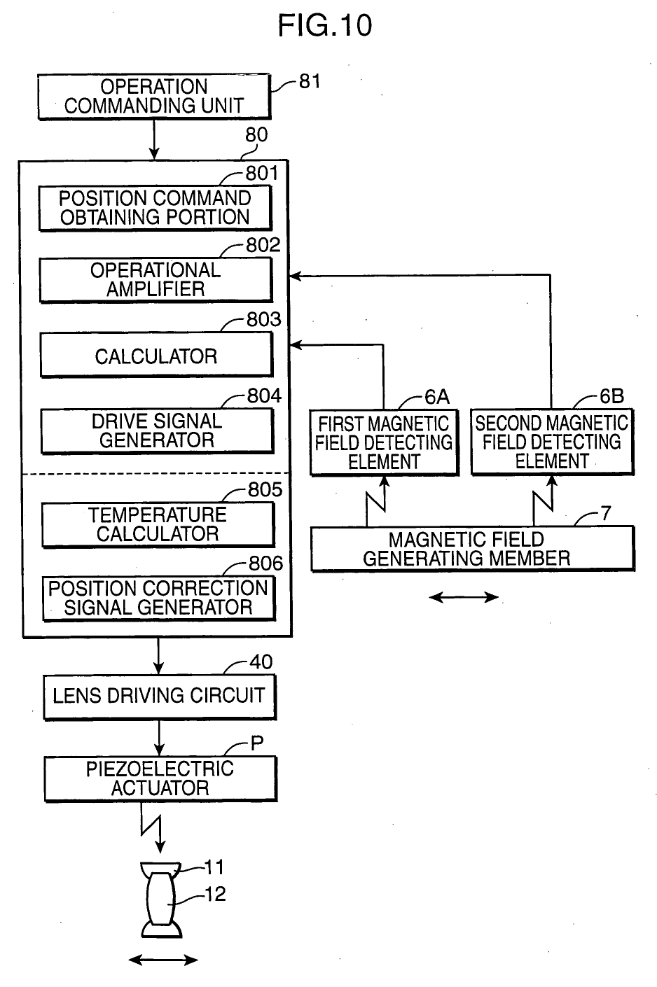

FIG. 10 is a block diagram showing one exemplary control system of the optical apparatus shown in FIG. 9. This optical apparatus is provided with a control unit 80 for generating a drive control signal used to control the operation of the piezoelectric actuator P to advance and the retreat the lens 12 in accordance with the position information of the movable member 3 detected by the first and second magnetic field detecting elements 6A, 6B, an operation commanding unit 81 for giving commands concerning the movements of the lens 12 to the control unit 80, and a lens driving circuit 40 for generating an actual lens driving signal (drive signal given to the piezoelectric actuator P) in accordance with the drive control signal generated by the control unit 80.

The control unit 80 includes a position command obtaining portion 801, an operational amplifier 802, a calculator 803, a drive signal generator 804, a temperature calculator 805, and a position correction signal generator 806. If the control unit 80 is compared with the embodiment shown in FIG. 2, the operational amplifier 802 corresponds to the first and second adders 8A, 8B and the calculator 803 corresponds to the calculator 8C.

The position command obtaining portion 801 receives a movement command signal given from the operation commanding unit 81 to the lens 12 and temporarily saves it. This movement command signal is, for example, a focusing control signal in the case that the optical apparatus is an image sensing apparatus.

The operational amplifier 802 is a summing amplifier or the like, and receives a detection signal representing the magnetic field generated by the magnetic field generating member 7 and outputs it to the calculator 803 after amplifying it. The calculator 803 calculates the position information of the movable member 3, i.e., the current position information of the lens 12 by carrying out a calculation in accordance with the following equation:
K·(A−B)/(A+B) (where K is a proportion constant)
when it is assumed that an electrical signal outputted from the first magnetic field detecting element 6A is an output A and the one outputted from the second magnetic field detecting element 6B is an output B.

The drive signal generator 804 compares assumed position information of the lens 12 assumed from the movement command signal obtained by the position command obtaining portion 801 and the current position information of the lens 12 calculated by the calculator 803 to obtain a necessary moved amount of the lens 12 (lens holder 11), and generates the control drive signal for the piezoelectric actuator P necessary for such a movement.

The temperature calculator 805 calculates a temperature at a location where the magnetic field detecting elements are disposed, for example, in accordance with a signal value of the output A from the first magnetic field detecting element 6A or a signal value of the output B from the second magnetic field detecting element 6B or a sum of the outputs A and B given from the calculator 803. This is for calculating the operating environment temperature information of the piezoelectric actuator P, taking advantage of the change in the surface magnetic flux density of the magnetic field generating member 7 with temperature as described above.

The position correction signal generator 806 generates a position correction signal used to correct the control drive signal obtained by the drive signal generator 804 in accordance with the temperature information calculated by the temperature calculator 805. This is for the purpose of correcting the moved amount of the lens 12 in consideration of a temperature dependency to achieve more precise focusing in the case that the optical element as the drivable element has a temperature dependency resulting from a dimensional change, e.g., in the case that the lens 12 is a plastic lens and slightly elongates or contracts upon a temperature change. One exemplary construction of the position correction signal generator 806 may include, for example, a look-up table (LUT) relating the temperature dependency of the lens 12 and the moved amount of the movable member and a calculating portion for comparing the temperature detected by the temperature detector and the LUT to obtain a moved amount for correction.

The position correction signal generated by the position correction signal generator 806 is sent to the drive signal generator 804 to add a specified correction to the control drive signal generated by the drive signal generator 804. The control drive signal having such a temperature correction made thereto is sent to the lens driving circuit 40 and converted into the drive signal for the piezoelectric actuator P to drive the piezoelectric actuator P by the lens driving circuit 40. Thus, the lens 12 is moved to a position commanded by the operation commanding unit 81.

The optical element such as a photographing optical system or a light pickup is positioned with strict inclination precision to an optical-axis direction and required to have an excellent linearity and a high positioning precision. With the optical apparatus thus constructed, the optical element (lens 12) is driven using the piezoelectric actuator A. Thus, the excellent linearity is exhibited since the driving member 2 itself has a function as the guiding shaft and the high positioning precision can be achieved through a feedback control using the position information of the movable member 3 detected by the magnetic field detector 6.

Since the position of the movable member 3 is detected in accordance with two output signals from the first and second magnetic field detecting elements 6A, 6B in the calculator 803, the position can be precisely detected without being substantially influenced by a change in the operating environment temperature of the optical apparatus. Further, since the temperature is calculated in accordance with the output value(s) from the first and/or second magnetic field detecting elements 6A, 6B by the temperature calculator 805 and the position correction signal is generated based on this temperature information by the position correction signal generator 806 to add a correction conforming to the operating environment temperature to the control drive signal, there is an advantage of being able to execute a precise movement control even if the optical element (lens 12) as the drivable member has a temperature dependency resulting from a dimensional change. In other words, the temperature characteristic of the entire optical system in the optical apparatus can be compensated for.

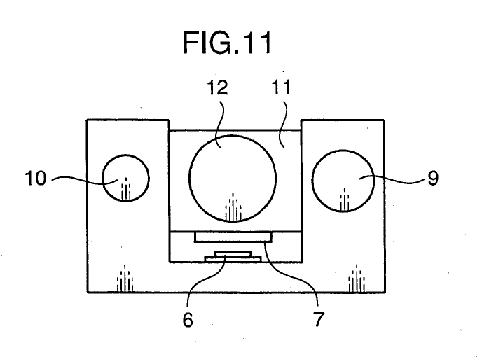

Although the magnetic field generating member 7 is mounted at the side of the auxiliary shaft 10 in the embodiment shown in FIG. 9, it may be disposed right below the lens holder 11 as shown in FIG. 11. Since the magnetic field generating member 7 is mounted very close to the lens 12 in this construction, the lens 12 can be more precisely controllably driven to an aimed position.

The arrangement of the magnetic field generating member 7 and the magnetic field detector 6 may be reversed, i.e., the magnetic field detector 6 may be arranged on the movable member 3 or a movable part of the lens holder 11 and the magnetic field generating member 7 may be arranged on a fixed part. Even in such a case, the substantially same operations as above can be carried out.

In the above construction, the lens of the light pickup optical system may be set as the drivable member and an aberration may be corrected by moving this lens along the optical-axis direction as the movable member advances and retreats. In other words, the lens may be driven using the inventive driving device to suppress the influence of the aberration to a minimum level in order to correct an image disturbance resulting from the spherical aberration and color aberration of the lens.

As described above, an inventive driving device comprises a movable member movable along a direction, a magnetic field generating member integrally attached to the movable member, a driver for moving the movable member in the direction, a magnetic field detector for detecting a change in a magnetic field resulting from a movement of the magnetic field generating member as the movable member moves, and a calculator for calculating the position of the movable member in accordance with a detection signal of the magnetic field detector.

The surface magnetic flux density of the magnetic field generating member changes along the moving direction of the movable member. The magnetic field detector includes a plurality of magnetic field detecting elements fixedly juxtaposed near a movement path of the magnetic field generating member.

With this construction, the position of the movable member can be calculated by detecting a change in the magnetic field resulting from the movements of the magnetic field generating member integrally attached to the movable member. Further, since the magnetic field is detected by a plurality of magnetic field detecting elements fixedly juxtaposed near the movement path of the magnetic field generating member, the position of the movable member can be detected without being substantially influenced by a change in the operating environment or temperature change of the driving device if the calculator carries out a comparison and a calculation in accordance with the detection signals outputted from the respective magnetic field detecting elements. Thus, there is an effect of being able to precisely detect the position of the movable member even if the driving device is exposed to a large environmental change, e.g., a large temperature change.

Preferably, the density of the surface magnetic fluxes generated as the movable member of the driver moves may be 0.1 mT or lower, and a maximum value of the density of the surface magnetic fluxes generated by the magnetic field generating member may be 1 mT or higher in the above construction.

Particularly preferably, the driver may include a piezoelectric actuator including an electromechanical converting element, and a driving member fixed to one end of the electromechanical converting element. The movable member is movably held onto the driving member. If the driving device using the movable member whose surface magnetic flux density is 0.1 mT (in this connection, geomagnetism is about 0.05 mT), i.e., the driving device of the aforementioned “non-magnetic source type”, particularly the driving device using the piezoelectric actuator is used and the magnetic field generating member a maximum value of whose surface magnetic flux density is 1 mT or higher is further used, the influence of the driver on the detection of the magnetic field can be substantially avoided, thereby obviating the need for bypass filtering to the detection signal of the magnetic field detector. Thus, the driving device can have a simple and inexpensive construction.

Particularly, in the case where the piezoelectric actuator is used for the driver, there is an advantage that the driver has a good mountability into a small-sized driving device.

Preferably, the magnetic field detector may include a first magnetic field detecting element and a second magnetic field detecting element disposed adjacent to the first magnetic field detecting element along the moving direction of the movable member, both magnetic field detecting elements being adapted to output electrical signals in accordance with a detected magnetic field. The calculator carries out a calculation in accordance with an equation:
K·(A−B)/(A+B) (where K is a proportion constant)
Wherein A denotes an electrical signal outputted from the first magnetic field detecting element, and B denotes an electrical signal outputted from the second magnetic field detecting element.

With this construction, the position of the movable member can be detected through the two magnetic field detecting elements: the first and second magnetic field detecting elements and the above relatively simple calculation in accordance with the above equation using the outputs of the two magnetic field detecting elements without being influenced by a change in the detection characteristic of the magnetic field detecting elements resulting from the change in the operating environment. Thus, the position of the movable member can be precisely detected by a relatively simpler construction even if the driving device is exposed to a temperature change.

Further, the driving device may further comprise a temperature detector for detecting a temperature at a portion where the magnetic field detecting elements are disposed in accordance with a value of the electrical signal A outputted from the first magnetic field detecting element or a value of the electrical signal B outputted from the second magnetic field detecting element or a sum of the values of the electrical signals A, B. In such a case, the driving device preferably may further comprise a position corrector for correcting a moved position of the movable member in accordance with temperature information detected by the temperature detector.

The magnetic field detecting elements are in principle disposed to detect the position of the movable member. Generally, the detection outputs of the magnetic field detecting elements change as an ambient temperature changes. Accordingly, if the magnetic field detecting elements are used as temperature sensors taking advantage of this characteristic thereof, various controls (operating position control, etc.) of the driving device can be executed using temperature detection results. In other words, the control function of the driving device can be extended by using the temperature detection results. For example, since the driving device having the position corrector can correct the operating position thereof using the temperature detection results, the movement of the movable member can be controlled in view of the influence of the temperature change.

In the above construction, the magnetic field detecting elements of the magnetic field detector may be preferably Hall elements. Although various magnetic field detecting elements can be used and the types of the magnetic field detecting elements are not particularly restricted, Hall elements are preferable out of numerous magnetic field detecting elements because being generally small-sized, easily mountable into the driving device of this type and inexpensive. The use of the Hall elements makes the driving device smaller and less expensive.

Preferably, the magnetic field detector may be fixedly disposed to face the magnetic field generating member that moves together with the movable member, and the shape of the magnetic field generating member is selected such that magnetic fluxes from the magnetic field generating member act on the magnetic field detector over the entire movable range of the movable member. Thus, the position of the movable member can be detected over the entire stroke of the movable member.

In the above construction, the magnetic field generating member may preferably include a positively magnetized portion dominantly positively magnetized, a negatively magnetized portion dominantly negatively magnetized, and an intermediate portion disposed between the positively and negatively magnetized portions for canceling the positive magnetization and negative magnetization, the three portions being arranged along the moving direction of the movable member.

With this construction, the magnetic field generating member comprised of the positively magnetized portion, the negatively magnetized portion and the intermediate portion and, therefore, having magnetism creating conditions that differ along the moving direction of the movable member moves as the movable member moves. Thus, the magnetic field largely changes as the movable member moves, with the result that a change in the magnetic field can be detected with a high resolution by the magnetic field detector. Thus, there is an advantage of being able to detect the position of the movable member in a fine order.

In this construction, the magnetic field generating member may preferably include a substantially triangular first magnet positively magnetized in thickness direction and a substantially triangular second magnet negatively magnetized in thickness direction and has a substantially rectangular shape by securing facing oblique sides of the first and second magnets to each other. With this construction, the positively and negatively magnetized portions are smoothly switched. Thus, this construction is suitably applied to a driving device in which a movable member is movable within a relatively large range. In this case, a change in the magnetic fluxes resulting from the movement of the magnetic field generating member appears not only along the moving direction of the movable member, but also along a direction normal to a surface extending along the moving direction. Thus, a plurality of magnetic field detecting elements can be juxtaposed not only along the moving directions of the movable member, but also along a direction normal thereto.

The magnetic field generating member may include a substantially rectangular first magnet positively magnetized in thickness direction and a substantially rectangular second magnet negatively magnetized in thickness direction and have a substantially rectangular shape by securing facing sides of the first and second magnets to each other.

With this construction, the positively and negatively magnetized portions are linearly switched. Thus, the magnetic field can be largely changed even by a slight movement of the movable member. Therefore, this construction is suitably applicable to a driving device in which a movable member is movable within a relatively small range.

An inventive optical apparatus comprises an optical system including at least one optical element disposed on an optical axis; a holder for holding the optical element, the holder being movable in a direction; a magnetic field-generating member integrally attached with the holder; an actuator for moving the holder in the direction to move the optical element; a magnetic field detector for detecting a change in a magnetic field resulting from a movement of the magnetic field generating member as the holder moves; and a calculator for calculating the position of the holder in accordance with a detection signal of the magnetic field detector.

The surface magnetic flux density of the magnetic field generating member changes along the moving direction of the holder. The magnetic field detector includes a plurality of magnetic field detecting elements fixedly juxtaposed near a movement path of the magnetic field generating member.

In this construction, the optical element may be preferably held by the holder such that an optical axis thereof is parallel with the moving direction of the holder. Thus, there is an effect of being able to detect the position of the holder by an inexpensive and simple construction without being influenced by a change in the operating environment.

Preferably, the optical apparatus may be an image sensing apparatus and the optical element is an optical element constructing a part of a photographing optical system of the image sensing. Thus, there is an advantage that a zoom lens or the like of the photographing optical system can be precisely driven by an inexpensive and simple construction without being influenced by a change in the operating environment in the image sensing apparatus such as an electronic camera.

Further preferably, the optical apparatus may be a light pickup apparatus and the optical element is an optical element constructing a part of a light pickup optical system of the light pickup apparatus. Thus, there is an advantage that a lens or the like of the light pickup optical system can be precisely driven by an expensive and simpler construction without being influenced by a change in the operating environment in the light pickup apparatus. In this case, it is preferable that the optical element is a lens of the light pickup optical system and an aberration is corrected by moving the lens along an optical-axis direction as the holder moves. Thus, the convenience of the driving device can be further improved.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

1. A driving device, comprising:
a movable member movable along a direction;
a magnetic field generating member integrally attached to the movable member;
a driver for moving the movable member in the direction;
a magnetic field detector for detecting a change in a magnetic field resulting from a movement of the magnetic field generating member as the movable member moves; and
a calculator for calculating the position of the movable member in accordance with a detection signal of the magnetic field detector;
wherein:
the surface magnetic flux density of the magnetic field generating member changes along the moving direction of the movable member; and
the magnetic field detector includes a plurality of magnetic field detecting elements fixedly juxtaposed near a movement path of the magnetic field generating member.

2. A driving device according to claim 1, wherein the density of the surface magnetic fluxes generated by the movement of the movable member is 0.1 mT or lower, and a maximum value of the density of the surface magnetic fluxes generated by the magnetic field generating member is 1 mT or higher.

3. A driving device according to claim 2, wherein: the magnetic field detector includes:
a first magnetic field detecting element and a second magnetic field detecting element disposed adjacent to the first magnetic field detecting element along the moving direction of the movable member, both magnetic field detecting elements being adapted to output electrical signals in accordance with a detected magnetic field; and
the calculator executes a calculation in accordance with an equation:
K·(A−B)/(A+B) (where K is a proportion constant)
wherein A denotes an electrical signal outputted from the first magnetic field detecting element, and B denotes an electrical signal outputted from the second magnetic field detecting element.

4. A driving device according to claim 2, wherein the driver includes a piezoelectric actuator having an electromechanical converting element, and a driving member fixed attached to one end of the electromechanical converting element, and the movable member is movably held onto the driving member.

5. A driving device according to claim 4, wherein: the magnetic field detector includes:
a first magnetic field detecting element and a second magnetic field detecting element disposed adjacent to the first magnetic field detecting element along the moving direction of the movable member, both magnetic field detecting elements being adapted to output electrical signals in accordance with a detected magnetic field; and
the calculator executes a calculation in accordance with an equation:
K·(A−B)/(A+B) (where K is a proportion constant)
wherein A denotes an electrical signal outputted from the first magnetic field detecting element, and B denotes an electrical signal outputted from the second magnetic field detecting element.

6. A driving device according to claim 5, further comprising a temperature detector for detecting a temperature at a portion where the magnetic field detecting elements are disposed in accordance with a value of the electrical signal A outputted from the first magnetic field detecting element or a value of the electrical signal B outputted from the second magnetic field detecting element or a sum of the values of the electrical signals A, B.

7. A driving device according to claim 6, further comprising a position corrector for correcting a moved position of the movable member in accordance with temperature information detected by the temperature detector.

8. A driving device according to claim 1, wherein the magnetic field detecting elements of the magnetic field detector are Hall elements.

9. A driving device according to claim 8, wherein the magnetic field detector is fixedly disposed to face the magnetic field generating member that moves together with the movable member, and the shape of the magnetic field generating member is selected such that magnetic fluxes from the magnetic field generating member act on the magnetic field detector over the entire movable range of the movable member.

10. A driving device according to claim 9, wherein the magnetic field generating member includes a positively magnetized portion dominantly positively magnetized, a negatively magnetized portion dominantly negatively magnetized, and an intermediate portion disposed between the positively and negatively magnetized portions for canceling the positive magnetization and negative magnetization, the three portions being arranged along the moving direction of the movable member.

11. A driving device according to claim 10, wherein the magnetic field generating member includes a substantially triangular first magnet positively magnetized in a thickness direction and a substantially triangular second magnet negatively magnetized in a thickness direction and has a substantially rectangular shape by securing facing oblique sides of the first and second magnets to each other.

12. A driving device according to claim 10, wherein the magnetic field generating member includes a substantially rectangular first magnet positively magnetized in a thickness direction and a substantially rectangular second magnet negatively magnetized in a thickness direction and has a substantially rectangular shape by securing facing sides of the first and second magnets to each other.

13. A driving device according to claim 1, wherein: the magnetic field detector includes:
a first magnetic field detecting element and a second magnetic field detecting element disposed adjacent to the first magnetic field detecting element along the moving direction of the movable member, both magnetic field detecting elements being adapted to output electrical signals in accordance with a detected magnetic field; and
the calculator executes a calculation in accordance with an equation:
K·(A−B)/(A+B) (where K is a proportion constant)
wherein A denotes an electrical signal outputted from the first magnetic field detecting element, and B denotes an electrical signal outputted from the second magnetic field detecting element.

14. A driving device according to claim 1, wherein the magnetic field detector is fixedly disposed to face the magnetic field generating member that moves together with the movable member, and the shape of the magnetic field generating member is selected such that magnetic fluxes from the magnetic field generating member act on the magnetic field detector over the entire movable range of the movable member.

15. A driving device according to claim 1, wherein the magnetic field generating member includes a positively magnetized portion dominantly positively magnetized, a negatively magnetized portion dominantly negatively magnetized, and an intermediate portion disposed between the positively and negatively magnetized portions for canceling the positive magnetization and negative magnetization, the three portions being arranged along the moving direction of the movable member.

16. An optical apparatus, comprising:
an optical system including at least one optical element disposed on an optical axis;
a holder for holding the optical element, the holder being movable in a direction;
a magnetic field generating member integrally attached with the holder;
an actuator for moving the holder in the direction to move the optical element;
a magnetic field detector for detecting a change in a magnetic field resulting from a movement of the magnetic field generating member as the holder moves; and
a calculator for calculating the position of the holder in accordance with a detection signal of the magnetic field detector;
wherein:
the surface magnetic flux density of the magnetic field generating member changes along the moving direction of the holder; and
the magnetic field detector includes a plurality of magnetic field detecting elements fixedly juxtaposed near a movement path of the magnetic field generating member.

17. An optical apparatus according to claim 16, wherein an optical axis of the optical element is parallel with the moving direction of the holder.

18. An optical apparatus according to claim 17, wherein the optical system is a part of a photographing optical system.

19. An optical apparatus according to claim 17, wherein the optical system a light pickup optical system.

20. An optical apparatus according to claim 19, wherein the optical element is a lens of the light pickup optical system, and the lens is moved along an optical axis of the light pickup optical system as the holder moves to correct an aberration.
